(19) United States
(12) Patent Application Publication
(10) Pub. No.: US 2013/0069761 A1
(43) Pub. Date: Mar. 21, 2013

(54) SYSTEM AND METHOD TO OPERATE AN EXTENDED RANGE KEYLESS ENTRY SYSTEM TO RECOGNIZE A KEYLESS ENTRY TRANSMITTER

(71) Applicant: CRAIG A. TIEMAN, WESTFIELD, IN (US)

(72) Inventor: CRAIG A. TIEMAN, WESTFIELD, IN (US)

(73) Assignee: DELPHI TECHNOLOGIES, INC., TROY, MI (US)

(21) Appl. No.: 13/238,378

(22) Filed: Sep. 21, 2011

(51) Int. Cl. G08B 29/00

(52) U.S. Cl. 340/5.64

(57) ABSTRACT

A communication system, an in-vehicle communication module, and a method for operating a keyless entry receiver in a vehicle to recognize a keyless entry transmitter. An internet server is used to store programming data for operating the keyless entry receiver to recognize the keyless entry transmitter. An in-vehicle communication module is used to communicate with a diagnostic bus of the vehicle to determine a vehicle identity, communicate with the internet server to download programming data corresponding to the vehicle identity, operate the keyless entry receiver into a learn mode via the diagnostic bus and in accordance with the programming data, and operate a keyless entry transmitter to transmit a keyless entry signal effective for the keyless entry receiver to recognize the keyless entry transmitter.

### TECHNICAL FIELD OF INVENTION

This disclosure generally relates to an extended range vehicle remote keyless entry (RKE) system, and more particularly relates to a way to install an in-vehicle communication module that communicates with a cellular network and a keyless entry transmitter.

### BACKGROUND OF INVENTION

Many vehicles are equipped with remote keyless entry (RKE) systems that operate certain aspects of the vehicle in response to a signal from a key-fob, such as locking or unlocking the vehicle doors, or starting the vehicle. U.S. patent application Ser. No. 13/118,844, entitled REMOTE KEYLESS ENTRY RELAY MODULE AND SYSTEM, filed May 31, 2011, and having the same first named inventor and assigned to the same assignee as this application, describes a system that extends the range of a RKE system by arranging for a mobile communication device such as a cellular phone to communicate with an in-vehicle communication module in a vehicle via a cellular phone network. The module includes a keyless entry transmitter so the module can transmit RKE signals and thereby mimic a RKE key-fob. The entire contents of U.S. Ser. No. 13/118,844 are hereby incorporated by referenced herein.

When the module with a new (i.e.—previously unrecognized) keyless entry transmitter is first installed in a vehicle, the vehicle's keyless entry receiver must be placed into a “learn” mode to enable the keyless entry receiver to recognize the new keyless entry transmitter in the module. On many vehicles, this process is performed with special test equipment connected to a diagnostic bus in the vehicle. What is needed is a way to get the RKE system in the vehicle to recognize the new keyless entry transmitter without requiring the services of a professional installer or the purchase of special test equipment.

### SUMMARY OF THE INVENTION

In accordance with one embodiment, a communication system for operating a keyless entry receiver in a vehicle to recognize a keyless entry transmitter is provided. The system includes an internet server and an in-vehicle communication module. The internet server is configured to store programming data for operating the keyless entry receiver to recognize the keyless entry transmitter The in-vehicle communication module is configured to communicate with a diagnostic bus of the vehicle to determine a vehicle identity, communicate with the internet server to download programming data corresponding to the vehicle identity, operate the keyless entry receiver into a learn mode via the diagnostic bus and in accordance with the programming data, and operate a keyless entry transmitter to transmit a keyless entry signal effective for the keyless entry receiver to recognize the keyless entry transmitter.

In another embodiment, an in-vehicle communication module for operating a keyless entry receiver in a vehicle to recognize a keyless entry transmitter is provided. The module includes a connector, a processor, a transceiver, and a keyless entry transmitter. The connector is configured to make electrical contact with a diagnostic bus of the vehicle. The processor is configured to communicate with the diagnostic bus to determine a vehicle identity. The transceiver is configured to communicate with an internet server to download programming data corresponding to the vehicle identity. The processor is further configured to operate the keyless entry receiver into a learn mode via the diagnostic bus and in accordance with the programming data. The keyless entry transmitter is operable to transmit a keyless entry signal effective for the keyless entry receiver to recognize the keyless entry transmitter.

In yet another embodiment, a method for operating a keyless entry receiver in a vehicle to recognize a keyless entry transmitter is provided. The method includes the step of determining a vehicle identity of the vehicle via a diagnostic bus of the vehicle. The method also includes the step of downloading programming data corresponding to the vehicle identity into an in-vehicle communication module. The method also includes the step of operating the keyless entry receiver into a learn mode via a diagnostic bus of the vehicle and in accordance with the programming data. The method also includes the step of transmitting a keyless entry signal effective for the keyless entry receiver to recognize the keyless entry transmitter.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of a communication system in accordance with one embodiment;

FIG. 2 is a diagram of a communication system in accordance with one embodiment; and

FIG. 3 is a flowchart for operating a communication system in accordance with one embodiment.

### DETAILED DESCRIPTION

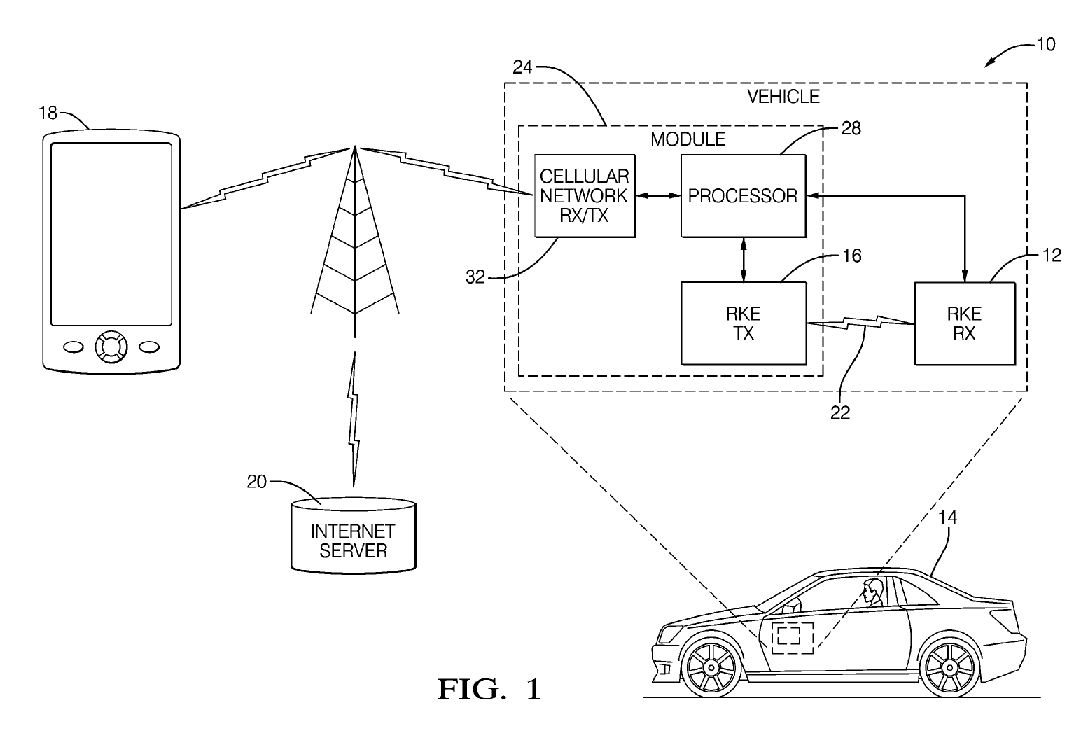

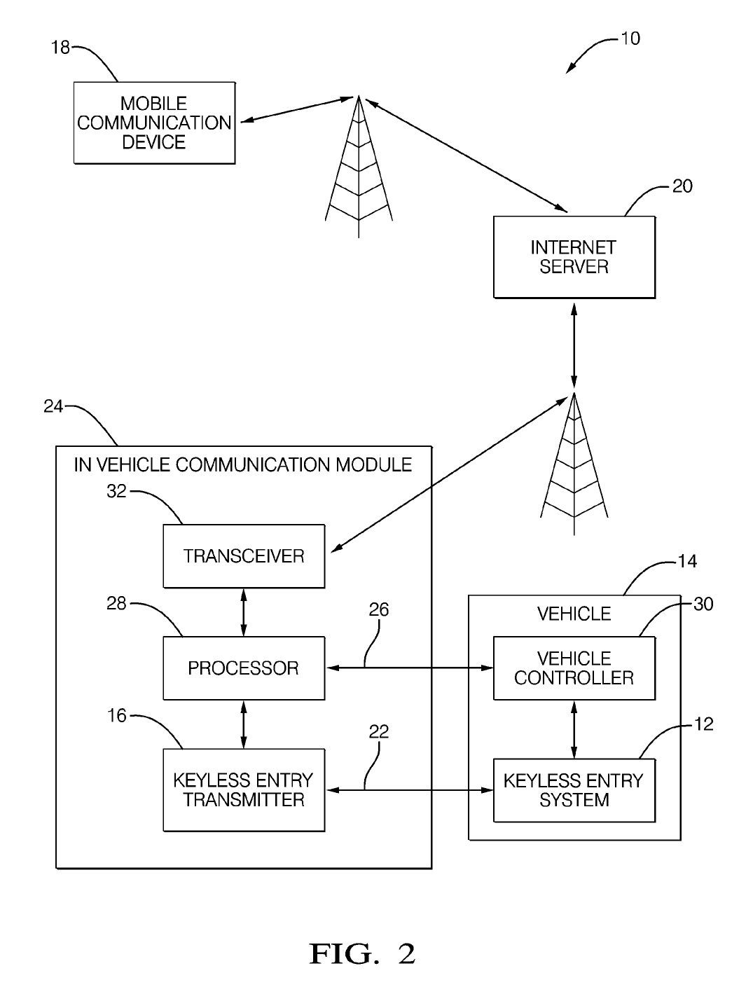

FIGS. 1 and 2 illustrate non-limiting examples of a communication system 10 for operating a keyless entry receiver 12 in a vehicle 14 to recognize a keyless entry transmitter 16. In general, the communication system 10 provides a means for a mobile communication device 18, such as a smart phone, tablet, or personal computer, to send remote keyless entry (RKE) like command signals so remote keyless entry actions such as unlocking the vehicle doors or starting the vehicle engine can be executed by entering commands into the mobile communication device 18. In particular, the description set forth herein is directed to the process by which the keyless entry receiver 12 is programmed to accept signals from the keyless entry transmitter 16.

The communication system 10 may include an internet server 20 configured to store programming data for operating the keyless entry receiver 12 in order to recognize the keyless entry transmitter 16. The programming data may include a sequence of codes or software steps that when delivered to the keyless entry receiver 12 puts the keyless entry receiver 12 into a ‘learn’ mode of operation. The programming data may also include a key-fob profile so the keyless entry transmitter transmits a keyless entry signal 22 with the proper transmitting frequency and/or a signal encryption setting that the keyless entry receiver 12 can decode so the proper RKE system action is carried out. In other words, the keyless entry transmitter 16 may be programmed in accordance with the programming data to transmit a keyless entry signal 22 corresponding to a key-fob profile.

The programming data to operate the keyless entry receiver 12 to the learn mode, or to configure or program the keyless entry transmitter 16 may be entered by, for example, connecting to a personal computer. Alternatively, and advantageously, the communication system may include an in-vehicle communication module 24 configured to communicate with a diagnostic bus 26 of the vehicle 14 to determine a vehicle identity. The diagnostic bus may be, for example, an On-Board-Diagnostics type 2 bus (OBDII) or may be an Assembly Line Diagnostic Link (ALDL). As such, the in-vehicle communication module 24 may include a connector (not shown) sized and shaped to make electrical contact with the diagnostic bus 26 of the vehicle 14. The vehicle identity may be in the form of a vehicle identification number (VIN) unique to each vehicle, or may be in the form of manufacturer, model, year of manufacturer type information. Whatever the form, the vehicle identity may be used to determine what programming data is needed to operate the keyless entry receiver 12 and configure the keyless entry transmitter 16.

The in-vehicle communication module 24 may include a processor 28. The processor 28 may include a microprocessor or other control circuitry as should be evident to those in the art. The processor 28 may include memory, such as electrically erasable programmable read-only memory (EEPROM) for storing one or more routines, thresholds or captured data. The one or more routines may be executed for processing signals received by the processor 28 as described herein. FIG. 1 illustrates that the processor 28 is in direct communication with the keyless entry receiver 12 via the diagnostic bus 26. Alternatively, as illustrated in FIG. 2, the processor 28 may communicate with a vehicle controller 30, such as an engine control module (ECM), or a body control module (BCM), or other controller capable of communicating with the keyless entry receiver 12.

The in-vehicle communication module 24 may include a transceiver 32 configured to communicate with an internet server 20 to download programming data corresponding to the vehicle identity. The transceiver 32 may be a cellular network type transceiver as are found in cellular phones, or it may be a Wi-Fi type transceiver as is found in many personal computers. The transceiver 32 advantageously communicates with the internet server to download programming data corresponding to the vehicle identity so the person installing the in-vehicle communication module 24 is not burdened with the task of manually entering programming data into the in-vehicle communication module 24 and risking entering incorrect programming data. Once the in-vehicle communication module 24 determines the vehicle identity and downloads the appropriate programming date, the in-vehicle communication module 24 is prepared to operate the keyless entry receiver 12 into a learn mode via the diagnostic bus 26 and in accordance with the programming data. The in-vehicle communication module 24 may also prepared to operate the keyless entry transmitter 16 to transmit a keyless entry signal 22 effective for the keyless entry receiver 12 to recognize the keyless entry transmitter 16.

In one embodiment, the keyless entry transmitter 16 is integrated within the in-vehicle communication module. Alternatively, the keyless entry transmitter 16 may be removable so that the keyless entry transmitter 16 could be used in the same manner as a key-fob. It is recognized that if the keyless entry transmitter 16 is removed from the vehicle 14 by a distance greater than the transmitting range of the keyless entry transmitter 16, the communication system 10 will not be able to, for example, open the vehicle door or start the vehicle engine by way of entering commands into the mobile communication device 18.

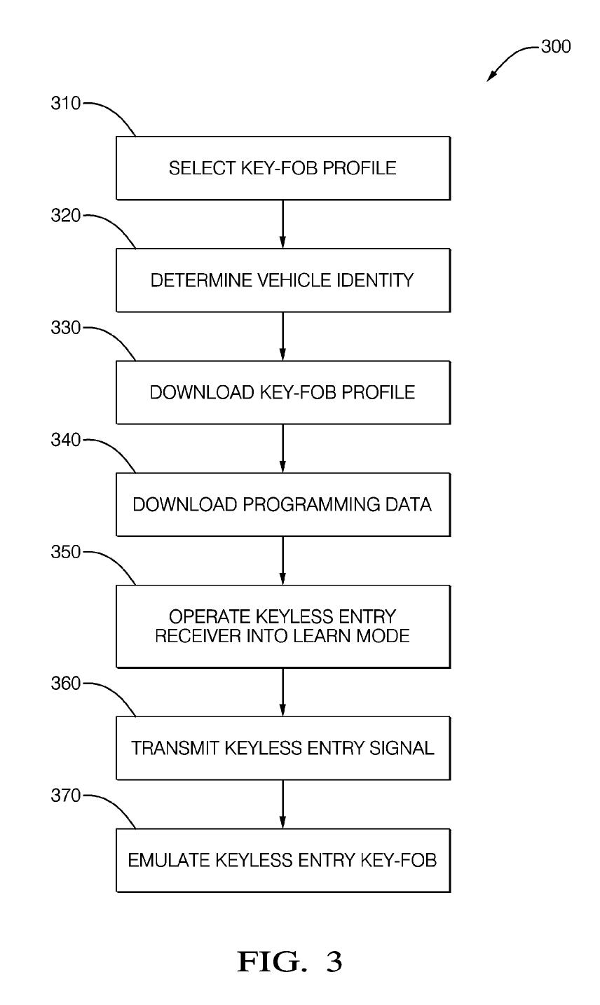

FIG. 3 illustrates a non-limiting example of a method 300 for operating a keyless entry receiver in a vehicle to recognize a keyless entry transmitter.

Step 310, SELECT KEY-FOB PROFILE, may include selecting a key-fob profile using a mobile communication device 18 in communication with an internet server 20. The key-fob profile may include data that determines how the display of the mobile communication device 18 will appear when the mobile communication device 18 is being used to send remote keyless entry commands

Step 320, DETERMINE VEHICLE IDENTITY, may include determining a vehicle identity of the vehicle via a diagnostic bus of the vehicle. This step may be initiated by the mobile communication device 18 communicating with the in-vehicle communication module 24.

Step 330, DOWNLOAD KEY-FOB PROFILE, may include downloading the key-fob profile into the mobile communication device 18 from the internet server 20

Step 340, DOWNLOAD PROGRAMMING DATA, may include downloading programming data corresponding to the vehicle identity into the in-vehicle communication module 24 and/or downloading the key-fob profile into the in-vehicle communication module 24.

Step 350, OPERATE KEYLESS ENTRY RECEIVER INTO LEARN MODE, may include operating the keyless entry receiver 12 into a learn mode via the diagnostic bus 26 of the vehicle 14 and in accordance with the programming data.

Step 360, TRANSMIT KEYLESS ENTRY SIGNAL, may include transmitting a keyless entry signal 22 effective for the keyless entry receiver 12 to recognize the keyless entry transmitter 16 and/or transmitting a keyless entry signal 22 corresponding to the key-fob profile.

Step 370, EMULATE KEYLESS ENTRY KEY-FOB, may include the mobile communication device 18 and the in-vehicle communication module 24 communicating via an internet server 20. As such, the mobile communication device 18 may emulate the appearance and/or features of a keyless entry key-fob based on the key-fob profile

In general, the operation of the communication system 10 when installing an unrecognized keyless entry transmitter may be characterized as process steps where the communication system 10: A) obtains necessary programming data from the internet server 20, B) programs the keyless entry transmitter 16, C) places a vehicle in keyless entry receiver 12 into a “learn” mode, and D) causes keyless entry receiver 12 to learn a new keyless entry transmitter, for example the keyless entry transmitter 16.

The following is only for the purpose of further explanation and not limitation. Upon installation and powering-up of the in-vehicle communication module 24 while connected to the diagnostic bus 26, the vehicle's unique VIN is read from the diagnostic bus 26 in order to identify the vehicle 14, i.e.—determine a vehicle identity. A user input and display device (e.g. smart phone, tablet, PC) may be connected to the in-vehicle communication module 24 directly or communication may be established via a cloud datacenter or internet server 20 to provide progress information and request input from the installer at appropriate times.

The communication system 10 may access the cloud datacenter and provides the vehicle identity (e.g. VIN) to the datacenter or internet server 20, and requests the correct keyless entry programming data for the identified vehicle. The cloud datacenter may respond with all potential key-fob choices which may be available for the particular vehicle and presents those choices to the installer. The installer may choose the correct key-fob profile for the vehicle and the correct programming data for the key-fob profile is downloaded to the in-vehicle communication module 24. The in-vehicle communication module 24 may operate in order to put the keyless entry transmitter 16 into a programming mode to configure the transmitter for the particular vehicle.

Upon completion of programming the keyless entry transmitter 16, the in-vehicle communication module 24 commands the vehicle to enter the keyless entry receiver 12 into a learn mode and the keyless entry transmitter 16 into a programming mode using specific commands sent over the diagnostic bus 26. The specific procedures appropriate for the particular vehicle are followed, which would typically be for the in-vehicle communication module 24 to command the keyless entry transmitter 16 to broadcast certain RF commands or signals to the vehicle's keyless entry receiver 12 while it is in the learn mode. Upon completion of learn mode, the communication system 10 would be returned to a normal operational state and the in-vehicle communication module 24 and vehicle remote extension system could be tested for proper operation.

By way of a further example explanation, a mobile communication device 18 executing a smart phone app may prompt an installer to initiate programming. The VIN of the vehicle will be read from the OBDII bus and sent to the cloud server. The cloud server responds with a list of available choices and displays the choices on the smart phone app. An installer chooses one and data is downloaded to the mobile communication device 18. The keyless entry transmitter 16 is programmed with the downloaded data. The smart phone app displays progress and necessary steps to the installer and then commands the keyless entry receiver 12 into a keyless entry “learn” mode via OBDII bus commands. The in-vehicle communication module 24 commands appropriate RF commands from the keyless entry transmitter 16 for the keyless entry receiver 12 to learn. Upon completion of keyless entry transmitter learning, the vehicle will now accept commands from the telematics device via the keyless entry transmitter

Accordingly, a communication system 10, an in-vehicle communication module 24 for the communication system 10 and a method 300 of operating a keyless entry receiver in a vehicle to recognize a keyless entry transmitter is provided. This provides a simple and convenient way for a vehicle owner to purchase an in-vehicle communication module 24, install that module into the owners vehicle by way of plugging it into a port or connector for the diagnostic bus 26, and then using a smart phone so the vehicle's remote keyless entry system can learn or recognize the keyless entry transmitter associated with the in-vehicle communication module 24. As such, the vehicle owner can set up to use his/her smart phone to send keyless entry commands to the vehicle via a cellular phone network and so extend the range that remote keyless entry commands can be sent to any distance when cellular phone or Wi-Fi communications are available to the mobile communication device 18 (smart phone) and the vehicle 14.

While this invention has been described in terms of the preferred embodiments thereof, it is not intended to be so limited, but rather only to the extent set forth in the claims that follow.

1. A communication system for operating a keyless entry receiver in a vehicle to recognize a keyless entry transmitter, said system comprising:
an internet server configured to store programming data for operating the keyless entry receiver to recognize the keyless entry transmitter; and
an in-vehicle communication module configured to communicate with a diagnostic bus of the vehicle to determine a vehicle identity, communicate with the internet server to download programming data corresponding to the vehicle identity, operate the keyless entry receiver into a learn mode via the diagnostic bus and in accordance with the programming data, and operate a keyless entry transmitter in communication with the communication module to transmit a keyless entry signal effective for the keyless entry receiver to recognize the keyless entry transmitter, wherein the internet server is configured to communicate with a mobile communication device such that the mobile communication device is able to initiate the operation of the keyless entry receiver into the learn mode in a manner effective to recognize the keyless entry transmitter.

2. The system in accordance with claim 1, wherein the keyless entry transmitter is programmed in accordance with the programming data to transmit a keyless entry signal corresponding to a key-fob profile.

3. The system in accordance with claim 2, wherein the programming data includes transmitting frequency and signal encryption settings for the keyless entry transmitter that correspond to the vehicle identity.

4. The system in accordance with claim 1, further comprising a mobile communication device configured to communicate with the in-vehicle communication module via the internet server effective to operate the keyless entry receiver to recognize the keyless entry transmitter.

5. The system in accordance with claim 4, wherein the internet server is further configured to store a key-fob profile, and the mobile communication device is configured to download the key-fob profile and emulate a keyless entry key-fob based on the key-fob profile

6. The system in accordance with claim 5, wherein the programming data includes the key-fob profile so the keyless transmitter is programmed to transmit a keyless entry signal corresponding to the key-fob profile.

7. The system in accordance with claim 1, wherein the keyless entry transmitter is integrated within the in-vehicle communication module.

8-12. (canceled)

13. A method for operating a keyless entry receiver in a vehicle to recognize a keyless entry transmitter, said method comprising:
determining a vehicle identity of the vehicle via a diagnostic bus of the vehicle;
downloading programming data corresponding to the vehicle identity into an in-vehicle communication module, wherein the programming data is downloaded from an internet server in communication with the keyless entry transmitter;
operating the keyless entry receiver into a learn mode via a diagnostic bus of the vehicle and in accordance with the programming data, wherein operating the keyless entry receiver into the learn mode is initiated by a personal communication device in communication with the internet server; and
transmitting a keyless entry signal effective for the keyless entry receiver to recognize the keyless entry transmitter.

14. The method in accordance with claim 13, further comprising
selecting a key-fob profile;
downloading the key-fob profile into the in-vehicle communication module; and
transmitting a keyless entry signal corresponding to the key-fob profile.

15. The method in accordance with claim 14, wherein the step of selecting a key-fob profile is performed by a mobile communication device in communication with an internet server.

16. The method in accordance with claim 13, wherein the step of determining a vehicle identity is initiated by a mobile communication device communicating with the in vehicle communication module.

17. The method in accordance with claim 16, wherein the mobile communication device and the in vehicle communication module communicate via an internet server.

18. The method in accordance with claim 13, further comprising
selecting a key-fob profile;
downloading the key-fob profile into a mobile communication device; and
emulating a keyless entry key-fob with the mobile communication device based on the key-fob profile.
